(19) United States
(12) Patent Application Publication
(10) Pub. No.: US 2001/0037252 A1
(43) Pub. Date: Nov. 1, 2001

(54) Method and system for placing and accepting orders of commodities

(76) Inventor: Toshiro Kawakatsu, Osaka (JP)

Correspondence Address: PRICE, GESS & UBELL, Suite 250, 2100 S.E. Main Street, Irvine, CA, 92714, US

(21) Appl. No.: 09/790,291

(22) Filed: Feb. 22, 2001

(30) Foreign Application Priority Data
Mar. 17, 2000 (JP) 2000-75309

(51) Int. Cl. G06F 17/60

(52) U.S. Cl. 705/26

(57) ABSTRACT

This invention presents method and system for placing and accepting orders of commodities, by which sales opportunities are increased without losing buying wills of consumers by allowing consumers, who see pages of the magazines, to instantaneously buy published commodities.

This invention is constituted in such that an operator runs sites, which have contents in cooperation with pages of the magazines publishing a plurality of commodities on the Internet; a piece of information processing equipment at the operator side accepts orders of commodities among the above plurality of commodities from a piece of information processing equipment at the side of the consumers; and the operator places orders of each commodity to suppliers of each commodity, respectively, and supplies a set of commodities, which are grouped together for each consumer according to the contents of the above orders after receiving from each supplier, to each consumer.

### BACKGROUND OF THE INVENTION

1. Field of the Invention

The present invention relates to a method and system for placing and accepting orders of commodities.

2. Description of the Prior Art

Recently, information exchange using telecommunication circuits has been actively performed along with widespread of information processing equipment such as personal computers, and the same circumstances are applied to the commercial field. Especially, as the Internet has widely spread, consumers have been able to perform comparison for all kinds of commodities before purchasing them, using the Internet, and further to place orders for them through the Internet.

Moreover, suppliers of each commodity (shops affiliated with manufacturers, other than the manufacturers, are included, and hereinafter, called only as manufacturers) have run their own sites, actively using the Internet in order to promote the advertisement and sales of their own commodities. However, considering the current states in which there have been rapidly increased frauds and crimes using the Internet, many of consumers have resisted commercial transaction based on information open only on the Internet.

On the other hand, magazines containing information on various kinds of commodities have boosted consumer confidence by attractive publishing of information on noteworthy commodities in fields meeting the needs of consumers, selected from various kinds of commodities. The contents of the above magazines to be published have been usually decided through discussion with manufacturers of the commodities to be published, and the manufacturers have been expecting increase in sales of their commodities by distribution of the magazines.

However, conventional magazines (including information bulletins) have only introduced commodities and their related information on pages, that is, have only performed information distribution to the public. Therefore, in actual fact, there have been no understanding to what extent the published commodities in the magazines have actually attracted the attention of the consumers, and have been substantially bought.

Accordingly, publishers of the magazines have been required to separately perform questionnaire surveys in order to know the popularity ratings of articles in the magazines and each commodity. Moreover, there have been no means for manufacturers of the commodities to know to what extent the distribution of the magazines have effected on actual orders of the commodities.

On the other hand, the consumers only receive information from the magazines. And, if they find any commodities, which they want to buy, in the magazines, they have been required to visit stores dealing with the commodities and buy them. In the extreme case, there have been no names of manufacturers offering the commodities, and any pieces of information for purchase of the commodities have been not given to the consumers.

But, usually, information on the published commodities such as the manufacturers' names of the commodities has been contained on pages of the magazines, and the consumers have been required to search for the information on the manufacturers in the magazines. Then, the consumers who had obtained the information have called the publisher or manufacturers for inquiry about the information in the magazines, and replying to the inquiry have been an annoying job for the publishers and manufacturers.

Some of the magazines have disclosed the URL (uniform resource locator) of reliable sites, which are run by each manufacturer, and through which the consumers are able to buy commodities on the Internet (Internet shopping) But, in the conventional Internet shopping, the consumers have been required to make individual access to each site. And in many cases, the above sites have been advertising all the commodities, which are supplied by each manufacturer, in various kinds of displaying forms. Therefore, there have been a lot of wasted time for the consumers to find targeted commodities, and, in some case, they feel frustrated, as they have to see advertisements which they do not want to see.

Moreover, usually, the consumers have not be able to compare commodities of a plurality of manufacturers at a time, as information on other manufacturers have not been included on the sites run by each manufacturer. Similarly, there have been various kinds of payment methods for commodities bought through the conventional Internet shopping, and annoying jobs, for example, the consumers have been required to follow various kinds of payment methods according to the commodities of each manufacturers, in order to buy a set of commodities shown in the magazines.

And, even when a plurality of commodities are ordered almost at the same time, the consumers have been required to wait for the commodities at each different times, as each commodity has arrived at different times. As mentioned above, there have been various kinds of problems with buying commodities through conventional sites on the Internet.

That is, the consumers have been impossible to buy commodities immediately, though the consumers have the strongest will to buy the commodities, when they are reading magazines or information bulletins. Therefore, some of buying wills of the consumers have not been led to ordering of commodities or fruitful results of marketing. That is, in such circumstances, manufacturers and publishers have lost sales opportunities.

The present invention has been made in consideration of the above circumstances, and the object is to offer a method and system for placing and accepting orders of commodities, by which sales opportunities are increased without losing buying wills of consumers by allowing consumers, who see pages of the magazines, to instantaneously buy published commodities.

### SUMMARY OF THE INVENTION

The present invention has the following configuration in order to realize the above object.

That is, a method for placing and accepting orders of commodities according to a first invention have the features that an operator runs sites, which have contents in cooperation with pages of the magazines publishing a plurality of commodities on the Internet; a piece of information processing equipment at the operator side accepts orders of commodities among the above plurality of commodities from a piece of information processing equipment at the side of the consumers; and the operator places orders of each commodity to suppliers of each commodity, respectively, and supplies a set of commodities, which are grouped together for each consumer according to the contents of the above orders after receiving from each supplier, to each consumer.

Therefore, the consumers may check the information, which is cooperated with commodities or information published on pages of the magazines, on the sites to immediately find targeted commodities through the sites. Moreover, the consumers may be possible to place orders of commodities published on pages of the magazines to extremely easily buy targeted commodities on the above sites.

Especially, the consumers may buy commodities with a safe feeling, as they have previously evaluated the commodities on the pages of the magazines, different from the mail order purchases only through the Internet. Further, as the consumers may buy a plurality of commodities offered by each manufacturer at the same time only by one-time access to each site of a plurality of manufacturers, it may be possible to save time for buying the commodities and labors for payment of commodity costs and receiving of the commodities.

The publishers of magazines may be not required to include on the pages detailed information on methods for buying commodities, if addresses of the above sites are listed in the magazines, and then they may be able to perform more attractive editing of the pages.

In addition, both the publishers and the manufacturers may save annoying time for response to a rush of inquiries about the commodities from the consumers after sales of magazines. And the manufacturers may increase sales opportunities, as there is no loss of strengthened buying will of the consumers caused by sales of the magazines to directly cause sales of commodities.

When the above sites have image data including almost the same contents with those of the pages of the magazines, and it is possible to place orders of each commodity displayed as image data through the above sites, the consumer may find the commodities only considering the contents of the pages which they read, and immediately place orders of them. Thereby, they may place orders of targeted commodities without making notes of complex commodity codes, and with no errors.

Moreover, when the above sites are divided according to the pages of the magazines, and it is possible to order each commodity from a concentrated number of commodities by specification of a page through the information processing equipment at the consumer side, the cooperation between the magazines and the sites may be reliably performed, and the consumers may more quickly find targeted commodities by using pages, where targeted commodities are displayed, as a clue and order them.

Further, when the above information processing equipment at the operator side has a commodity information database collecting information related with each commodity, and the above information related with each commodity is displayed on the above sites to allow the consumers to perform selection and place orders of the most suitable commodities on the above sites, it may be possible to make more mature plans for buying commodities, as detailed information on commodities may be obtained, after the consumers find the targeted commodities. Especially, as detailed information on commodities may be obtained in the same form regardless of the difference in the manufacturers of the commodities by making the commodity information database, the consumers may more conveniently and easily conduct comparison with commodities of other companies.

When the above information processing equipment at the operation side records the historical data of ordered commodities through the above sites as an ordered commodity database, popularity ratings of commodities which the consumers have selected may be obtained. And, when the above operator notifies the historical data of the above ordered commodities to publishers of the magazines and/or suppliers of the commodities, the publishers of the magazines may obtain the popularity ratings of the articles published in the magazines to allow the suppliers of the commodities to increase or decrease the production number of the commodities. Specifically, the above suppliers of the commodities may make use of the above ordered commodity database as a reference for development of the next-generation commodities.

When the operator owns a warehouse of the above commodities; decides a predetermined number of each commodity required according to the contents of the pages; previously places orders of the predetermined number of each commodity from the suppliers of each commodity; keeps them in the above warehouse; and immediately supplies the commodities from the warehouse to the consumers after the order from the consumers, the time between the order and acceptance of commodities by the consumers may be shortened as much as possible, and, moreover, the costs for transportation of the commodities may be reduced. Moreover, suppliers of commodities may deliver commodities in units of a predetermined quantity, and the consumers may order the commodities in units of one piece. Therefore, the above may be useful, especially, for imported and limited production commodities. Other than the above, the above operator may control out of stock or excess one of each commodity as much as possible by notification of stocking states of each commodity to the suppliers of each commodity and by direction of increasing or decreasing stock.

A system for placing and accepting orders of commodities according to a second invention is characterized in that it comprises: an operator to place orders of commodities published in magazines to the corresponding suppliers of the commodities, respectively, to receive commodities from each supplier, and to supply a set of commodities, which are grouped together for each consumer according to the contents of the orders, to each consumer; a site on the Internet, which is run by the above operator, and has contents in cooperation with pages of magazines publishing a plurality of commodities; and an information processing equipment at the above operator to accept orders of a plurality of commodities among the above commodities from the information processing equipment at the consumer side through the above site.

### BRIEF DESCRIPTION OF THE DRAWINGS

FIG. 1 shows a general view of a system for placing and accepting orders of commodities according to an embodiment of the present invention.

FIG. 2 shows one embodiment of a homepage in a site which is given by the above system for placing and accepting orders of commodities, and is run by an operator.

FIG. 3 shows one embodiment of a Web page forming a part of the above site.

FIG. 4 shows one embodiment of a Web page forming a part of the above site.

FIG. 5 shows one embodiment of a Web page forming a part of the above site.

FIG. 6 shows one embodiment of a Web page forming a part of the above site.

FIG. 7 shows one embodiment of a Web page forming a part of the above site.

FIG. 8 shows one embodiment of a Web page forming a part of the above site.

FIG. 9 shows one embodiment of a Web page forming a part of the above site.

### DETAILED DESCRIPTION OF THE PREFERRED EMBODIMENTS

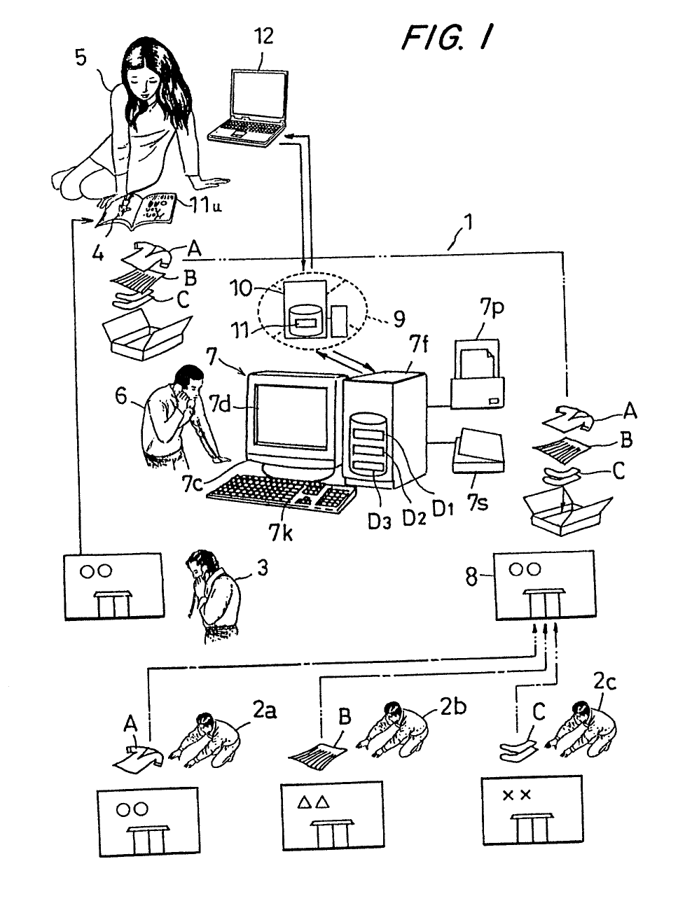

FIG. 1 shows a general view of a system for placing and accepting orders of commodities according to an embodiment of the present invention. In FIG. 1, 2a, 2b, and 2c are manufacturers (apparel manufacturers in the present embodiment, and hereinafter, called only as apparel) of various kinds of commodities A, B, C; 3 a publisher who publishes a magazine 4 (including an information bulletin), using commodities of A, B, and C of the above apparels 2a, 2b, and 2c; and 5 a consumer subscribing to the above magazine 4.

Here, though articles of clothing such as a shirt, and socks are illustrated as embodiments of the commodities A, B, and C in the present embodiment, the present invention is not limited to the apparel industry dealing with clothing, but it may deal with various kinds of commodities such as interior commodities, and stationery. Moreover, it is obvious that the present invention does not limit the number of manufacturers and that of commodity kinds, though an embodiment dealing with commodities A, B, and C of three manufacturers 2a, 2b, and 2c is disclosed for simplification of description in the present embodiment.

6 denotes an operator of the system for placing and accepting orders 1; 7 a piece of information processing equipment at the side of the operator 6; 8 a warehouse owned by the operator 6; 9 the Internet accessible through the above information processing equipment 7; 10 a Web server forming the Internet 9; 11 a Web site (hereinafter, called simply as site) which is run by the above operator 6, and stored in the Web server 10 by uploading with the information processing equipment 7; and 12 a piece of information processing equipment at the side of the consumer 5 to have an access to the Internet 9. In the drawing, only one Web server 10 is shown in the Internet 9 for simplification of description, but it is obvious that there are many Web servers 10 in reality.

That is, the above operator 6, the above information processor 7, the above warehouse 8, and the above site It on the Internet 9 form the system 1 for placing and accepting orders of commodities according to the present embodiment. And the magazine 4 is a component supporting the system 1 for placing and accepting orders according to the present invention, and the information processing equipment 12 at the side of the consumer works as a part of the system 1 for placing and accepting orders by access to the above site 11.

The above information processing equipment 7 comprises; for example, a display part 7d, an input device 7k such as a keyboard, a printer 7p, and a scanner 7s, other than a main body 7c and a database server 7f. Moreover, the above information processing equipment 7 is configured to upload the above site 11 by connection to the above Internet 9. The above database server 7f is a server for storing files connected to the main body 7c, comprising a recording device, which stores: a commodity information database D₁ for dealing commodities; a stock state data D₂ denoting a stocking state of commodities; a ordered commodity database D₃ showing the historical data of ordered commodities, such as hard disks.

However, the configuration of the information processing equipment 7 at the side of the operator 6 is not limited to that of the present embodiment. That is, in the present embodiment, separate installation of the database server 7f is configured to allow another information processing equipment owned by the operator 6 to more easily access to the above commodity information database D₁ and the stock state data D₂ through the Intranet at the side of the operator 6, but the present invention is not limited to the separate installation of the above database server 7f from the main body 7c. A device to store the data such as the above commodity information database D₁, and the above stock state data D₂ is not limited to the above hard drive, but may be an auxiliary storage device such as a MO (magneto-optical) disk.

Then, a process flow of the above system 1 for placing and accepting orders of commodities will be described below. In the first place, the publisher 3 has contact with each apparel 2a, 2b, 2c, and selects commodities A, B, C to be included in articles, when the contents of articles are determined for publishing the magazine 4. At this time, the operator 6 has contact with, at least, apparels 2a, 2b, 2c; previously places orders of a predetermined number of each commodity A, B C, based on prospected sales from the contents of the articles, to the above apparels 2a, 2b, 2c; and stores them in the warehouse

In the above case, orders of the commodities A, B, C from apparels 2a, 2b, 2c may be performed through paper, when the above information processing equipment 7 comprises a printer 7p. However, the above printer 7p may be also eliminated, when the above orders are configured to be electrically transmitted from the above information processing equipment 7. In the above case, it may be possible to eliminate labors for delivering of orders from the information processing equipment 7 to each apparel 2a, 2b, 2c, or to a manager of the warehouse 8.

The above operator 6 obtains detailed information on each commodity A, B, C from each apparel 2a, 2b, 2c; and the above detailed information is input through the keyboard 7k and the scanner 7s, and stored as the above commodity information database D₁. Here, it is obvious that contact between the operator 6 and the apparels 2a, 2b, 2c may be simplified by using electrical transmission and storage media for exchange of information on commodities and predetermined numbers for each commodity A, B, C, based on the prospected sales.

Then, the operator 6 has contact with the publisher 3 to obtain a sample of the magazine 4 to be published as the next issue; inputs the sample to the above information processing equipment 7, using the above scanner 7s and so on; and makes the site 11 in cooperation with pages in the next issue of the magazine 4. Thereafter, the above site 11 is uploaded to the Web server 10 upon sales of the magazines 4.

As the above information processing equipment 7 comprises the scanner 7s, the operator 6 may make the above site 11 by obtaining the contents of pages of the magazine 4 to be published through the scanner, but, it may be also possible to obtain the above contents of the pages from the publisher 3 in the data form, wherein the information processing equipment 7 is not required to comprise the scanner 7s. And data showing the above contents of the pages may be obtained by electrical transmission, and, also by using storage media such as a floppy disk and an MO disk.

On the other hand, when the consumer 5 reads the magazine 4, and finds favorite commodities, he/she finds the URL11u of the above site which is included on pages of the magazine 4; inputs the above URL11u into browser software installed in the information processing equipment 12 at the side of the consumer; accesses to the above site 11; and then is able to order of targeted commodities through the Internet 9.

For example, when the consumer 5 orders the shirt A,the skirt B, and the socks C published in the magazine 4 through the Internet 9, the operator 6 accepts the above orders through the information processing equipment 7. Thereafter, the operator 6 packs each commodity A, B, C, which had been stored in the warehouse 8, all together to deliver them to the consumer 5.

Here, it is evident that working to accept orders of the commodities A, B, C through the Internet 9 is not required to use the same information processing equipment as the one for uploading of the site 11. Moreover, the direction to deliver the commodities A, B, C may be performed through printed paper by the printer 7p , and also by communication between the above information processing equipment 7 and another piece of information processing equipment provided at the warehouse 8.

Under any configurations, the consumer 5 may quickly obtain the commodities A, B, C, which are ordered through the Internet 9 (that is, through the site 11). Especially, the consumer 5 have already evaluated the commodities in the magazine 4, and moreover, put confidence in the magazine 4 to cause no unnecessary uneasiness in buying them through the Internet 9.

Moreover, the consumer 5 may receive a set of commodities A, B, C at the same time by a single work with reduced time and less transportation cost, though different manufacturers 2a, 2b, 2c supply commodities A, B, C, respectively. Further, the operator 6 may perform a single payment of the commodity costs all together, and, then, the consumer 5 may have less annoying work and reduced fees. And, in some case, the operator 6 may supply the commodities A, B, C to the consumer 5 more cheaply by buying a large amount of commodities A, B, C together.

Thus, when the consumer 5 orders commodities A, B, C, the information processing equipment 7, which have accepted the orders of the commodities through the above site 11, collects the historical data of the ordered commodities to store them as the ordered commodity database D₃.

The historical data of the ordered commodities recorded in the above ordered commodity database D₃ are arranged according to pages in the magazine 4, and notified to the publisher 3 of the magazine 4. That is, the publisher 3 of the magazine 4 may guess the popularity ratings of each articles of the published magazine by using the system 1 for placing and accepting orders according to the present invention, and properly select an editing policy and models for future articles.

Similarly, the historical data of the ordered commodities recorded in the above ordered commodity database D₃ are arranged according to each commodity A, B, C, and notified to each apparel 2a, 2b, 2c. That is, the apparels 2a, 2b, 2c may guess the popularity ratings of each commodity A, B, C of their own by using the system 1 for placing and accepting orders according to the present invention, and properly control the future production quantities.

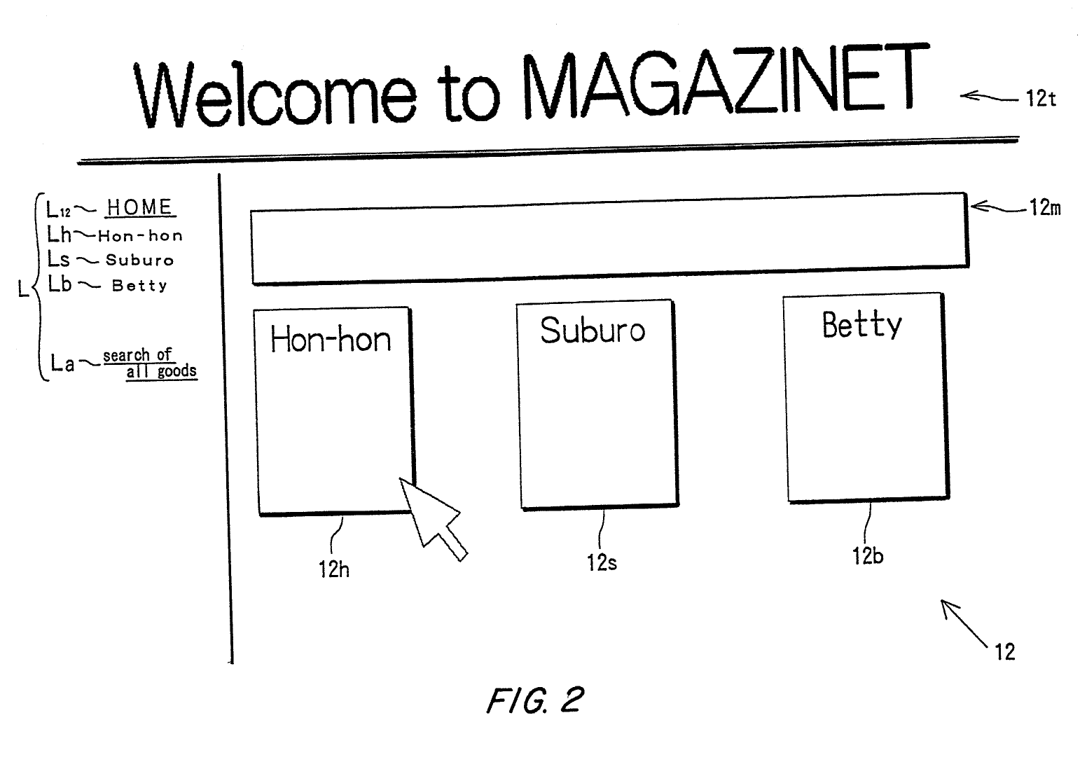

FIGS. 2-9 show embodiments of sites given by the above system 1 for placing and accepting orders of commodities.

FIG. 2 shows a homepage 12 of the above site 11, including: a title 12t of the above home page 12; a message 12m in the interactive mode; buttons 12h, 12s, 12b describing the titles, the issue numbers and so on of each magazine; and link buttons L for jump to each Web page forming the present site 11.

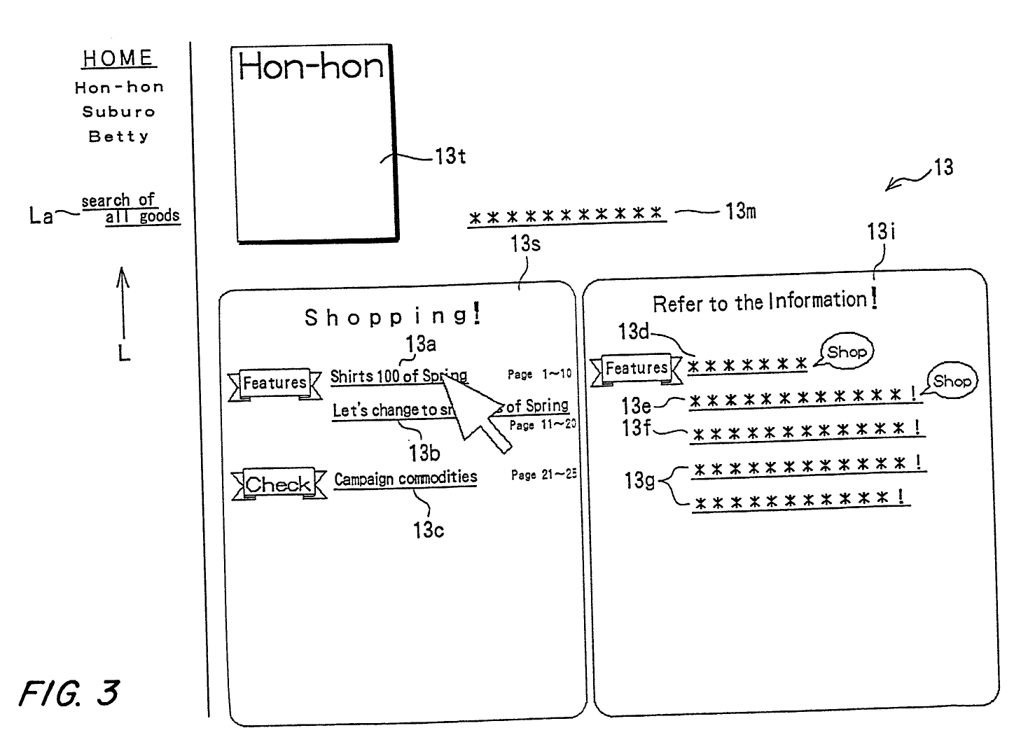

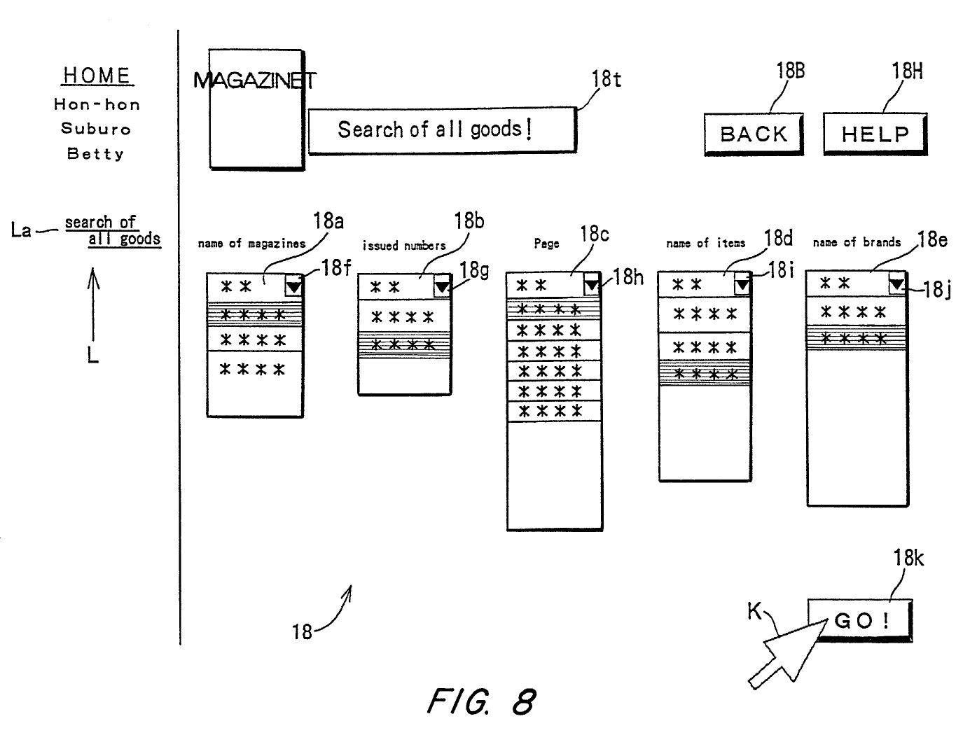

Further, there are displayed the same contents for link buttons L according to the present embodiment in any pages of FIGS. 3-8, where a link button L_{1 2} is for jump to the present home page 12; a link button Lh for jump to a Web page of a magazine with a name of “Hon-hon” shown in FIG. 3; link buttons Ls, Lb for jump to Web pages of two kinds of magazine “Suburo” and “Betty” (not shown); and a link button La for jump to a Web page for retrieval of all the commodities shown in FIG. 8.

Thereby, the consumer 5 may select the magazine “Hon-hon”, which the consumer have read, according to displayed buttons 12h, 12s, 12b, while the consumer 5 is in access to the site It through the information processing equipment 12.

FIG. 3 shows a configuration of a Web page of Hon-hon. The above Web page 13 includes: a title 13t of the above page; a message 13m in the interactive mode; frames 13s, 13i divided to two large parts; and the above link buttons L. Moreover, the shopping frame 13s includes the following buttons for jump to specific pages: buttons 13a, 13b for jump to Web pages of “Shirts 100 of Spring”, and “Let's change to sneakers of Spring” of “Features” articles in the magazine 4, respectively; and a button 13c for jump to a Web page of “Campaign commodities” of “Checks” article in the magazine 4.

The titles for the above buttons 13a, 13b. 13c have the same contents as those of articles of the magazine 4 “Hon-hon”, or they are simplified for easier identification. Moreover, page numbers for each articles are displayed at the same time to secure correspondence with the pages of the magazine 4. Thereby, the consumer 5 may easily jump to Web pages describing targeted commodities among the Web page 13.

In the frame 13i of “Refer to the Information !”, there are buttons 13d, 13e, 13f for jump to Web pages to refer to additional related information in the “Features” articles, and a button 13g for jump to a Web page with contents attracting interests of consumers in the contents of the magazine 4. Thereby, the publisher 3 is not required to include detailed information on shops on the pages of the magazine 4 to cause effective use of pages of the magazine and possibility to advertise the magazine 4 using the present Web page 13.

Now, it is assumed that the consumer 5 has selected favorite commodities in the feature article “Shirts 100 of Spring”. Then, the consumer 5 may easily find and select the button 13a in the shopping frame 13s.

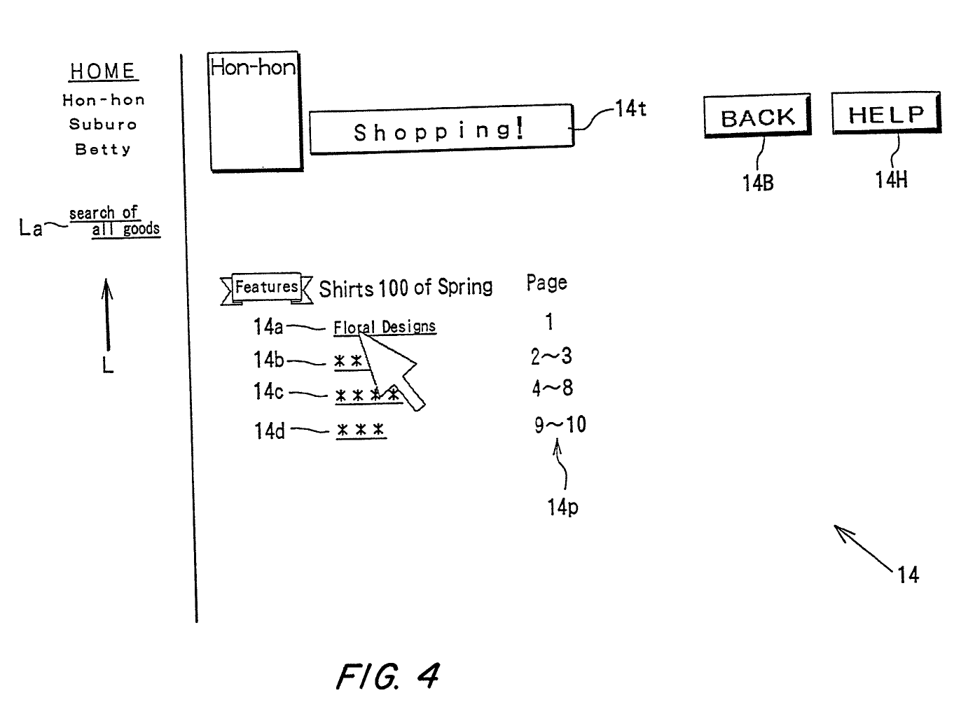

FIG. 4 shows a configuration of a Web page 14 for the Internet shopping, corresponding to the title “Shirts 100 of Spring” of the magazine 4. The present Web page 14 includes: a title 14t of the present page; buttons 14a-14d for jump to Web pages showing each feature content of the feature articles, respectively; indications 14p of the page numbers corresponding to each of the above feature contents; a button 14B for return to the previous Web page 13 shown in FIG. 3; a help button 14H for comments to show how to use the Web page when assistance is required; and the above link buttons L.

Thereby, the consumer 5 may easily find wanted information, as the present Web page 14 also secures correspondence with the pages of the magazine 4. Now, if it is assumed that the consumer 5 has selected favorite commodities from shirts with floral designs, the consumer 5 may extremely easily select the button 14a without any errors, while confirming that the corresponding page number of the magazine 4 is “1”.

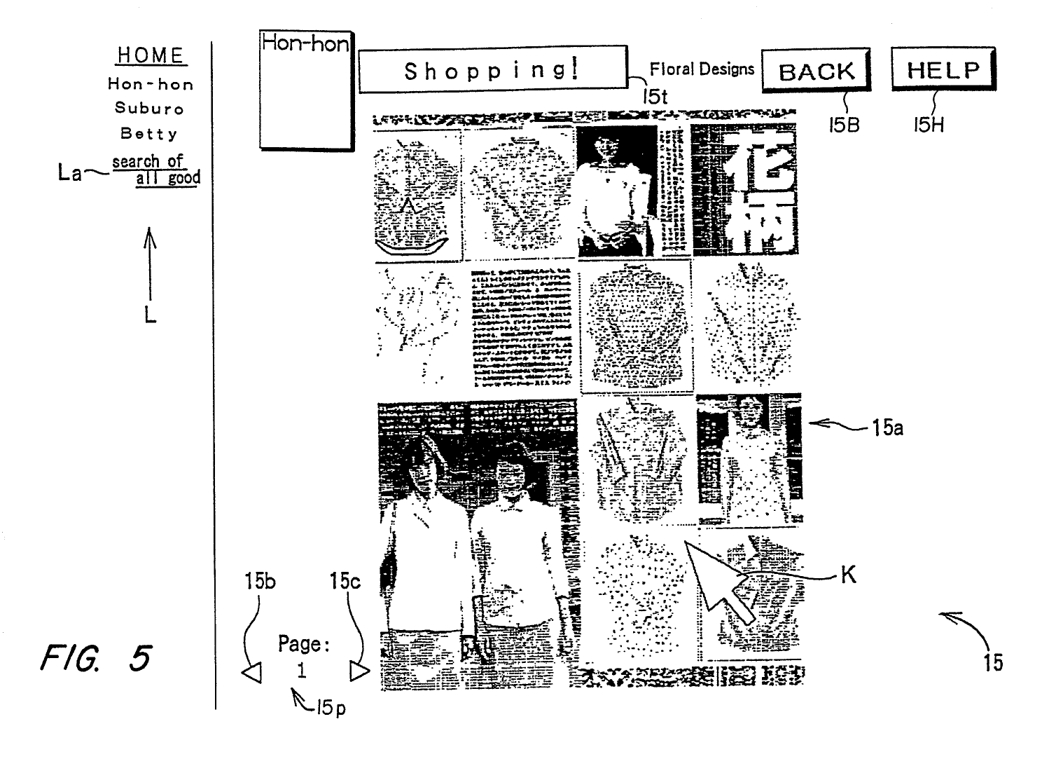

FIG. 5 shows a configuration of a Web page 15 for the Internet shopping, corresponding to the page “Floral Designs” described in the page 1 of the magazine 4. The present Web page 15 includes: a title 15t of the present page; a picture image 15a showing the content of the page 1 of the magazine 4; a corresponding page number 15t; buttons 15b, 15c to decrease and increase the page number, respectively; a button 15B for return to the previous Web page 14 shown in FIG. 4; a help button 15H for comments to show how to use the Web page when assistance is required; and the above link buttons L.

The above picture image 15a is image data with almost the same content as that of the page of the magazine 4, and the consumer 5 is configured to easily recognizes it. Here, the above image data are expressed to be almost the same as those of the pages of the magazine 4, as the picture image 15a displayed on the screen of the computer is difficult to be exactly the same as that of the page of the magazine 4.But, if there is no problem on the intellectual property right, it should be preferable that they are identical with each other as much as possible.

Moreover, linking is provided on the picture image 15a, according to positions of commodities displayed in the image, and clicking on each part in the picture image 15a may cause selection of a commodity corresponding to each part. That is, the present Web page 15 is in cooperation with the content of the page of the magazine 4, and the consumer 5 may surely select wanted commodities, referring to the magazine 4. Now, if the consumer is assumed to want to buy a second right most shirt at the bottom, the consumer may select it only by locating the cursor k on the position of the above shirt and clicking there.

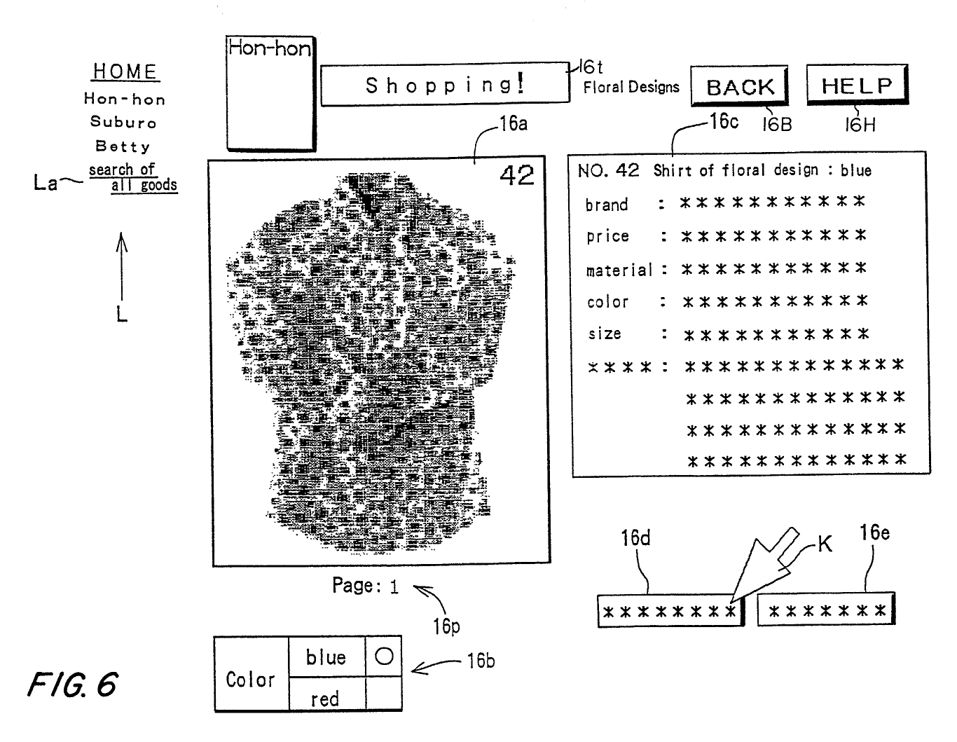

FIG. 6 shows a configuration of a Web page 16 for the Internet shopping, illustrating the details of the shirt selected by the above method. The present Web page 16 includes: a title 16t of the present page; a picture image 16a of the selected shirt; a switch 16b to select a variation of the above shirt; a frame 16c showing the detailed information of the commodity displayed on the picture image 16a; a button 16d for jump to a Web page to perform procedures for buying the displayed commodity; a button 16e to transmit inquiring mails for the commodity; a page 16p of the magazine 4 publishing the commodity; a button 16B for return to the previous Web page 15 shown in FIG. 5; a help button 16H for comments to show how to use the Web page when assistance is required; and the above link buttons L.

And linking is provided on each part of the above picture image 16a so as to obtain various kinds of detailed information such as a partially-enlarged picture, and a view from the back. The switch 16b is a switch to display the picture image 16a of variations of the commodity such as the one in other colors.

In addition, the content displayed in the above frame 16c displays information stored in the above commodity information database D1 in a predetermined form. That is, the consumer 5 may obtain detailed information on commodities before procedures for placing orders of the commodities, and buy the commodities with a safe feeling. Moreover, the consumer may perform wiser selection with full satisfaction, as the consumer may perform comparison of commodities in the same form, even if different apparels deal with each commodity, respectively.

The present embodiment is only one embodiment of the present invention, and it is evident that there may be various kinds of variations for display of commodities. That is, many useful functions for the consumer 5 may be provided by use of various kinds of databases D₁, D₂, and D₃ which are included in the system 1 for placing and accepting orders according to the present invention, for example, more detailed information is obtained, when each item in the frame 16c is specified, and information on the extent of the stocks of commodities which are prospected for the subsequent orders are displayed.

Now, when the consumer 5 has a reasonable feeling in buying the commodities, the consumer 5 may perform ordering procedure of the commodities by specification of the above buying button 16d.

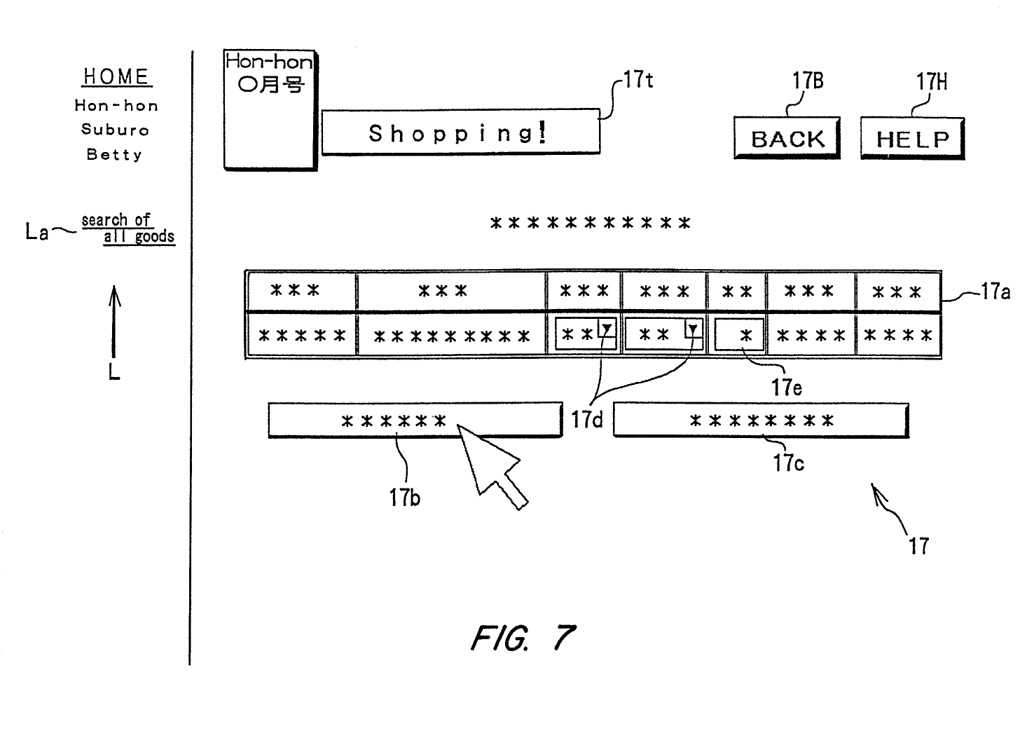

FIG. 7 shows a configuration of a Web page 17 illustrating a list of the commodities selected by the consumer 5. The present Web page 17 includes: a title 17t of the present page; a list of the commodities selected by the consumer: a button 17b for jump to a Web page to pay the costs of commodities among all the commodities displayed in the above list 17a; a button 17c to cancel the above list for reselection of commodities; a button 17B for return to the previous Web page 16 shown in FIG. 6; a help button 17H for comments to show how to use the Web page when assistance is required; and the above link buttons L.

The above list 17a includes: a button 17d to display a pull-down menu for selection of sizes, colors and so on of the commodities; and a window 17e to input a quantity of commodities. That is, the consumer 5 may perform buying procedure after reconfirmation of the sizes and colors of the commodities before the buying. The present Web page 17 is only one embodiment of the present invention, and it is evident that there may be various kinds of variations for display of commodities. For example, a button for additional buying of another commodity, and one to cancel specified commodities in the specified list 17a may be provided.

Moreover, the payment method for the commodities selected as mentioned above is not limited by the present invention. That is, the payment may be performed by inputting of a cashcard number on the Internet, transferring into an account of the consumer, or cash-on-delivery transportation. Conveniently, the consumer 5 may perform a single payment by any methods, even when a plurality of commodities offered by a plurality of apparels are bought, and, moreover, fees for the payment, and labors and fees for transportation may be reduced.

FIG. 8 shows a configuration of a Web page 18 for retrieval of all the commodities, which are displayed when the link button La for retrieval of all the commodities is specified on each Web page 12-17 in FIGS. 2-7. The present Web page 18 includes: a title 18t of the present page; input parts 18a-18e for selection of conditions such as names, issued numbers, and pages of the magazines, names of items, and names of brands; buttons 18f-18j for display of pull-down menus respectively at the above input parts; a button 18k for retrieval of a commodity among all the commodities under a predetermined conditions; a button 18B for return to the previous Web page; a help button 18H for comments to show how to use the Web page when assistance is required; and the above link buttons L.

That is, as the present page 18 is in close cooperation with the pages of the magazine 4, the consumer 5 may quickly find targeted commodities by specification of the pages of the magazine 4 and so on on the present Web page 18, while referring to the magazine 4. Moreover, the consumer 5 may be ale to find commodities, which had not been found only by the magazine 4, by changing the conditions. Now, if it is assumed that the above button 18k is specified after the consumer 5 selects each condition, the above Internet server 10 retrieves the commodities meeting the above conditions, and displays the results.

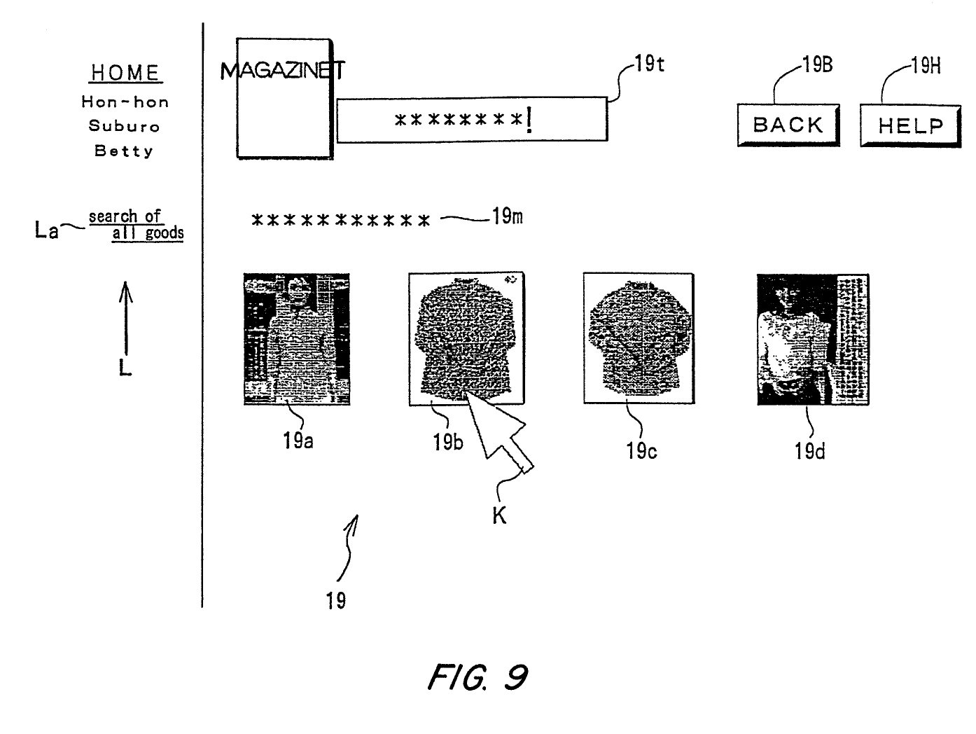

FIG. 9 shows a configuration of a Web page 19 illustrating the retrieved commodities. The present Web page 19 includes: a title 19t of the present page; a message 19m in the interactive mode; buttons 19a-19d displaying picture images of each retrieved commodity on them, respectively; a button 19B for return to the previous Web page 18 shown in FIG. 8; a help button 19H for comments to show how to use the Web page when assistance is required; and the above link buttons L.

The picture images displayed on the above buttons 19a-19d are image data with almost the same contents as those of the above pages of the magazine 4, and the consumer 5 easily recognizes them. Here, the above image data are expressed to be almost the same as those of the pages of the magazine 4, as the picture image displayed on the screen of the computer is difficult to be exactly the same as those of the pages of the magazine 4. But, if there is no problem on the intellectual property right, it should be preferable that they are identical with each other as much as possible.

Thereby, the consumer 5 may easily find targeted commodities. as the content of the present Web page 19 is also in close cooperation with that of the page of the magazine 4. Now, if the consumer specifies targeted commodities by locating the cursor k on them, the Web page 16 described in FIG. 6 is displayed, and the consumer may buy commodities in a method as already mentioned above.

Though the above embodiments according to the present invention are applied to an apparel industry as shown in detail in FIGS. 2-9, the present invention is not limited to the above, and may deal with various kinds of commodities. Therefore, it is evident that the contents stored in the commodity information database and the contents for optional conditions at buying commodities are required to be modified, depending on the kinds of the commodities.

That is, though detailed information on brand names,materials, colors, issued numbers, sizes, and so on are indicated in the frame 16 as shown in FIG. 6, and the above are peculiar to clothing, the information should be changed, depending on the kinds of the commodities. The variations of commodities selected with the switch 16b and so on are also required to be modified. Similarly, the contents of the list 17 shown in FIG. 7, and those of retrieval conditions shown in FIG. 8 should be properly changed according to treated commodities, too.

As mentioned above, the consumer may buy commodities offered by a plurality of commodity suppliers in the site on the Internet in cooperation with the pages of the magazines at a time, according to the present invention. Moreover, the consumer may quickly select targeted commodities, as the above site is in cooperation with the page of the magazines, that is, he/she may perform the Internet shopping. Further,the consumer may more quickly obtain commodities through the Internet shopping, and buy them with a safe feeling, as the information on the commodities may be confirmed by the magazines.

The publishers of the magazines and the suppliers of the commodities have been conventionally required to reply individually to a rash of inquiries from the consumers after sales of the magazines, but, according to the present invention, they have no necessity to make such individual replies to cause improved productivity by so much more concentration on their primary jobs.

And, popularity ratings of published magazines and offered commodities may be obtained to facilitate the future marketing activities, as data on ordered commodities may be feedbacked to the publishers and suppliers by making a database for information on buying records of consumers in the system for placing and accepting orders of commodities according to the present invention.

When the operator owns a warehouse of commodities; decides a predetermined number of each commodity required according to the contents of the pages of magazines; previously places orders of the predetermined number of each commodity from the suppliers of each commodity; keeps them in the above warehouse; and immediately supplies the commodities from the warehouse to the consumers after the orders from the consumers, consignment commodities by a plurality of suppliers may be quickly supplied to consumers, and the time between the order and acceptance of commodities by the consumers may be shortened as much as possible.

What is claimed is:

1. A method for placing and accepting orders of commodities characterized by being constituted in such that an operator runs sites, which have contents in cooperation with pages of the magazines publishing a plurality of commodities on the Internet; a piece of information processing equipment at the operator side accepts orders of commodities among the above plurality of commodities from a piece of information processing equipment at the side of the consumers; and the operator places orders of each commodity to suppliers of each commodity, respectively, and supplies a set of commodities, which are grouped together for each consumer according to the contents of the above orders after receiving from each supplier, to each consumer.

2. The method for placing and accepting orders of commodities as claimed 1, and further comprising that the above sites have image data including almost the same contents with those of the pages of the magazines, and it is possible to place orders of each commodity connected with the commodity displayed as image data through the above sites.

3. The method for placing and accepting orders of commodities as claimed 1 or 2, and further comprising that the above sites are divided according to the pages of the magazines, and it is possible to order each commodity from a concentrated number of commodities by specification of a page through the information processing equipment at the consumer side.

4. The method for placing and accepting orders of commodities according to either of claims 1 through 3 wherein the above information processing equipment at the operator side has a commodity information database collecting information related with each commodity, and the above information related with each commodity is displayed on the above sites to allow the consumers to perform selection and place orders of the most suitable commodities on the above sites.

5. The method for placing and accepting orders of commodities according to either of claims 1 through 4 wherein the above information processing equipment at the operation side records the historical data of ordered commodities through the above sites as an ordered commodity database.

6. The method for placing and accepting orders of commodities as claimed 5, and further comprising that the above operator notifies the historical data of the above ordered commodities to publishers of the magazines and/or suppliers of the commodities.

7. The method for placing and accepting orders of commodities according to either of claims 1 through 6 wherein the operator owns a warehouse of the above commodities; decides a predetermined number of each commodity required according to the contents of the pages; previously places orders of the predetermined number of each commodity from the suppliers of each commodity; keeps them in the above warehouse; and immediately supplies the commodities from the warehouse to the consumers after the order from the consumers.

8. The method for placing and accepting orders of commodities as claimed 7, and further comprising that the above operator notifies stocking states of each commodity to the suppliers of each commodity and directs to increase or decrease stock.

9. A system for placing and accepting orders of commodities characterized by comprising: an operator to place orders of commodities published in magazines to the corresponding suppliers of the commodities, respectively, to receive commodities from each supplier, and to supply a set of commodities, which are grouped together for each consumer according to the contents of the orders, to each consumer; a site on the Internet, which is run by the above operator, and has contents in cooperation with pages of magazines publishing a plurality of commodities; and an information processing equipment at the above operator to accept orders of a plurality of commodities among the above commodities from the information processing equipment at the consumer side through the above site.

10. The system for placing and accepting orders of commodities as claimed 9, and further comprising that the above sites have image data including almost the same contents with those of the pages of the magazines, and function that it is possible to place orders of each commodity connected with the commodity displayed as image data through the above sites.

11. The system for placing and accepting orders of commodities as claimed 9 or 10, and further comprising that the above sites are divided according to the pages of the magazines, and have function that it is possible to order each commodity from a concentrated number of commodities by specification of a page through the information processing equipment at the consumer side.

12. The system for placing and accepting orders of commodities according to either of claims 9 through 11 wherein the above information processing equipment at the operator side has a commodity information database collecting information related with each commodity, and the above sites has information related with each commodity displayed such that the information is able to support the consumers to perform selection and place orders of the most suitable commodities.

13. The system for placing and accepting orders of commodities according to either of claims 9 through 12 wherein the above information processing equipment at the operation side has an ordered commodity database recording the historical data of ordered commodities through the above sites.

14. The system for placing and accepting orders of commodities according to either of claims 9 through 13 wherein the operator decides a predetermined number of each commodity required according to the contents of the pages and owns a warehouse for keeping each commodities that are previously placed orders of the predetermined number from the suppliers of each commodity, and the above warehouse makes it possible to immediately supplies the commodities to the consumers after the order from the consumers.
